(19) United States
(12) Patent Application Publication
(10) Pub. No.: US 2010/0319468 A1
(43) Pub. Date: Dec. 23, 2010

(54) UNBURNED FLARE GAS SAMPLE SYSTEM

(75) Inventor: Tracy D. Peebles, Houston, TX (US)

Correspondence Address: HUSCH BLACKWELL LLP, 190 Carondelet Plaza, Suite 600, ST. LOUIS, MO, 63105, US

(73) Assignee: WELKER, INC., Sugar Land, TX (US)

(21) Appl. No.: 12/489,405

(22) Filed: Jun. 22, 2009

(51) Int. Cl. G01N 1/22

(52) U.S. Cl. 73/863.12

(57) ABSTRACT

A sample system withdraws a sample of unburned flare gas from a feed line and delivers a liquid free sample to a high pressure gas chromatograph for analysis. In one embodiment, the sample system may be fitted with an automatic insertion system. In other embodiments, the sample system may be static or have manual insertion. The sample system includes a liquid separator to separate liquids from the sample. In one embodiment, the sample system is housed in an insulated and heated cabinet to prevent condensation of liquids as the sample moves through the sample system.

### BACKGROUND OF THE INVENTION

In a refinery, petrochemical plant or on a drilling rig, it is common to have a flare to safely burn unwanted gases and vapors. If a plant suddenly shuts down due to an emergency, this is referred to as an “upset” in the industry and all combustible gases flowing through the plant may be shunted to the flare until the situation can be brought under control. All these unwanted gases and vapors are collectively referred to as “flare gas.”

It is common to sample and analyze the unburned flare gas before it comes into contact with the atmosphere and the burner at the end of the stack. Gas chromatographs (GCs) are commonly used to make this type of analysis. In order for the GC to make the best analysis of the unburned flare gas, the sample needs to be dry. Liquids may be entrained in the flare gas itself and liquids may form in the sample system as the sample passes through the system. It is therefore necessary to a) separate/remove any liquids and/or vapors from the sample of unburned flare gas and b) reduce and/or prevent the precipitation of liquids from the sample as it passes through the sample system and before it reaches the GC.

In some situations, unburned flare gas travels at speeds of from about 400 to about 900 feet per second while passing through the feed line to the flare stack. In some situations, unburned flare gas may range from approximately 200° F. to approximately 250° F. during regular operations of a plant. In some situations, during an upset, unburned flare gas may reach approximately 450° F. or more.

In some sample systems, a probe may be automatically inserted into the unburned flare gas line and from time to time automatically retracted; this type of system is referred to in the industry as an “automatic insertion system.” Welker, Inc, the assignee of the present invention, owns a number of patents that use automatic insertion systems as follows: U.S. Pat. Nos. 4,117,676; 4,346,611; 4,387,592; 4,631,967; 5,936,168; 6,085,777; 6,338,359. Welker also owns the following patents: U.S. Pat. No. 3,904,176 for a Dump Valve; U.S. Pat. No. 5,579,803 for an Automatic Liquid Shutoff; U.S. Pat. No. 6,764,536 for a Sampling Device with Liquid Eliminator and U.S. Pat. No. 6,818,045 for a Fluid Separator.

There is still a need for a better sample system for unburned flare gas that will a) separate entrained liquids from the unburned flare gas, b) reduce the formation of liquids while a sample is passing through the sample system, and c) selectively cool the unburned flare gas below the operational maximum of the sample system, during some situations, such as an upset. A delicate balance is required to keep liquids from reaching the GCs.

### SUMMARY OF THE INVENTION

The present invention is a sample system for unburned flare gas. A probe is used to take a continuous sample from the unburned flare gas feed line and deliver it to the sample system. The sample system may be produced in three different embodiments: a) automatic insertion, b) manual insertion and c) static.

As previously noted, GCs cannot analyze liquids. It is therefore necessary for the sample system to separate entrained liquids from the sample. The present invention includes a liquid separator to stop liquids from reaching the GCs. In one embodiment, the liquid separator may include a filter that will allow gas to pass through the filter, but not liquids. In one embodiment, the liquid separator may include a sump and drain located upstream of the filter to remove any liquids that may accumulate in the separator. In one embodiment, the liquid separator may include a ball-type liquid shut off valve positioned downstream of the filter to stop the flow of liquids and vapors to the GC, should the filter fail. In one embodiment, the sample system may include a sample gas tube formed with unequal diameters with the largest diameter in proximity to the stream of the flare gas. Should the liquid separator fail or merely need to be purged, a blowback system may be included to blow any liquids from the sample system. This blowback system uses an inert gas, such as nitrogen.

If the sample system is cold, it may precipate additional liquids from the sample as the sample moves through the sample system. A heating system may be provided to help reduce and/or prevent the precipitation of liquids as the sample moves through the sample system. Further, the sample system may be placed in a heated insulated cabinet to help maintain appropriate temperatures for the sample system. This is especially important during cold winter conditions.

During an upset, the temperatures of the unburned flare gas may spike upwards. A cooling system may be provided to help maintain temperatures below the operational maximum of the sample system.

### DETAILED DESCRIPTION OF THE DRAWINGS

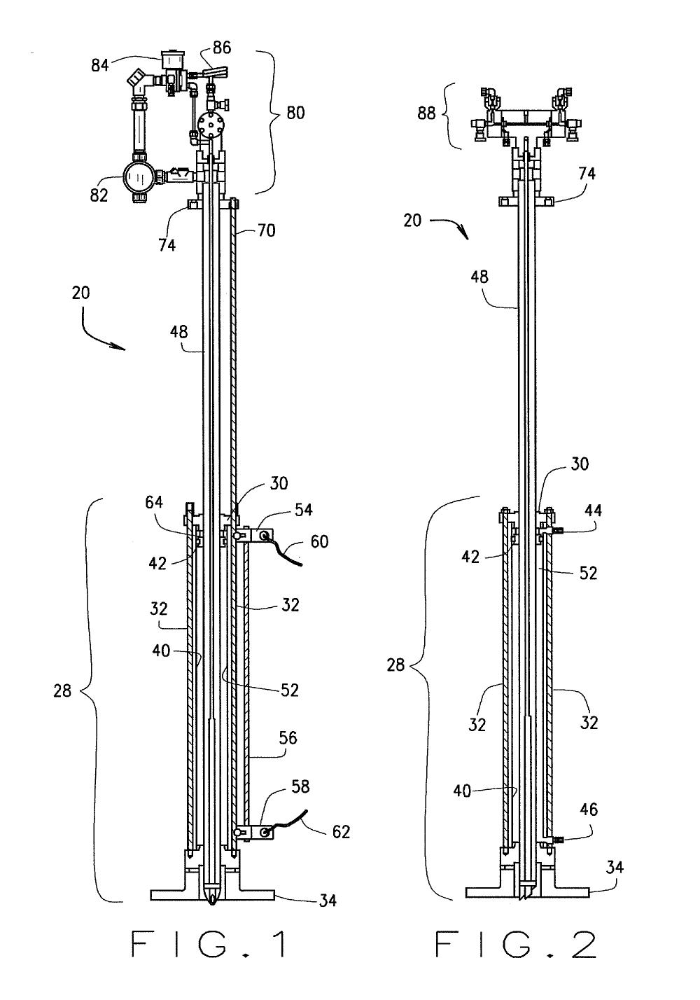

FIG. 1 is a section view of the unburned flare gas sample system with an automatic insertion system, with the probe withdrawn from the flare gas feed line, not shown in this figure.

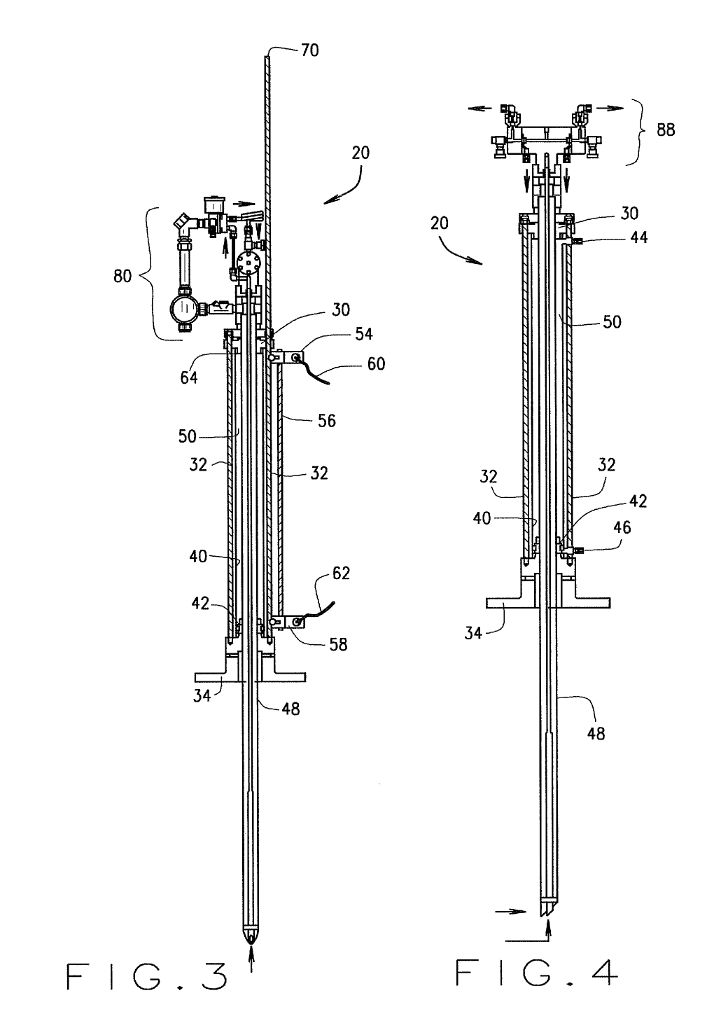

FIG. 2 is a section view of the unburned flare gas sample system of FIG. 1 but the apparatus has been rotated 90°.

FIG. 3 is a section view of the unburned flare gas sample system of FIG. 1 except the probe has been inserted into the flare gas feed line, not shown in this figure.

FIG. 4 is a section view of the unburned flare gas sample system of FIG. 1 except the probe has been inserted into the flare gas feed line, not shown and the apparatus has been rotated 90° from FIG. 1.

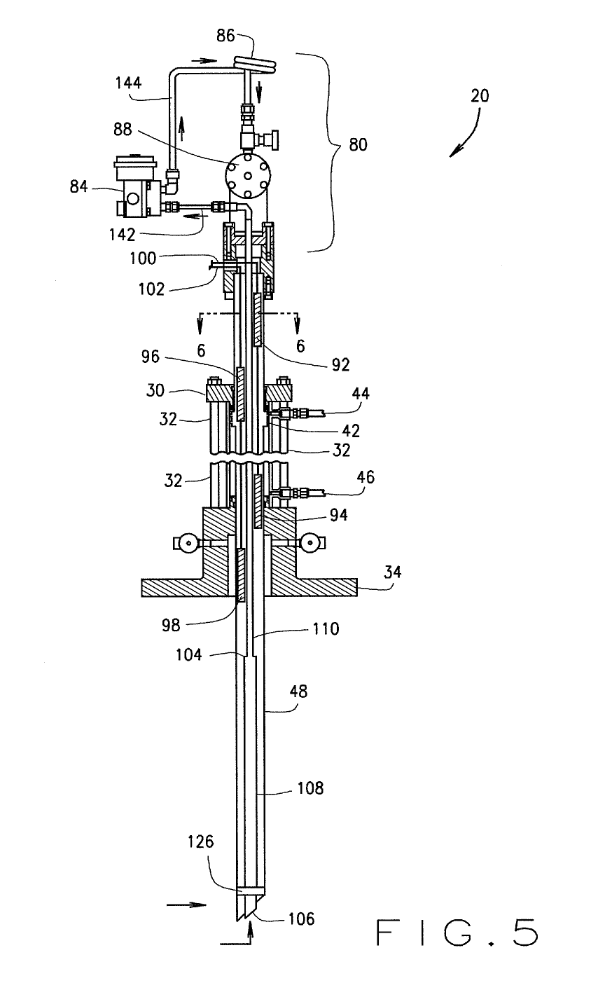

FIG. 5 is an enlarged section view of FIG. 1 to better show the four heaters in the probe. Flow arrows show the direction that the sample moves through the apparatus.

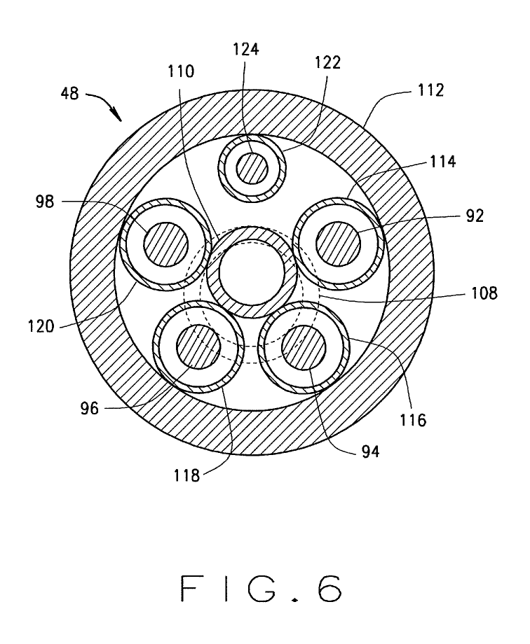

FIG. 6 is an enlarged section view along the line 6-6 of FIG. 5.

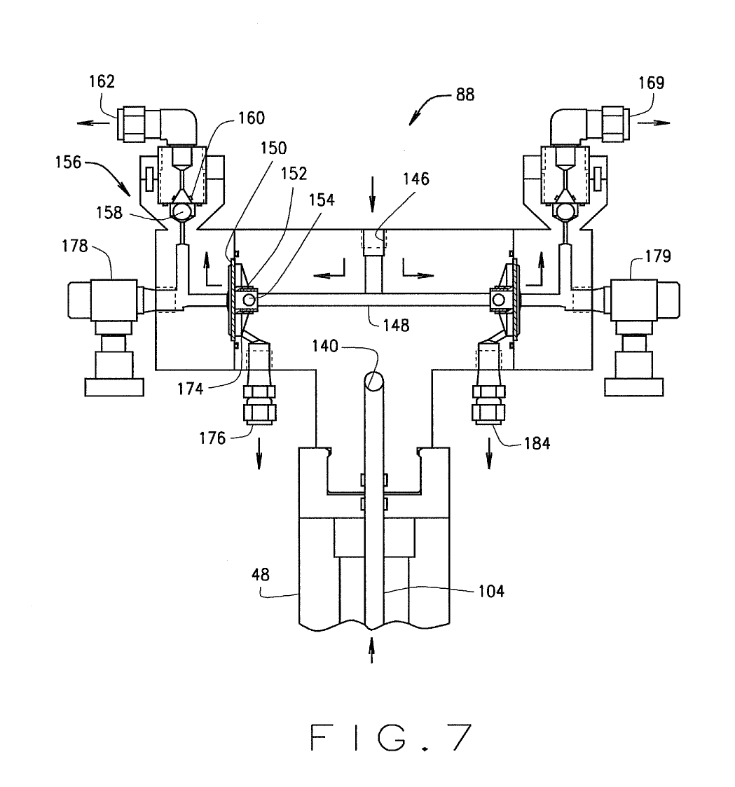

FIG. 7 is an enlarged section view of the liquid eliminator of FIG. 4. Flow arrows show the direction that the sample moves through the apparatus.

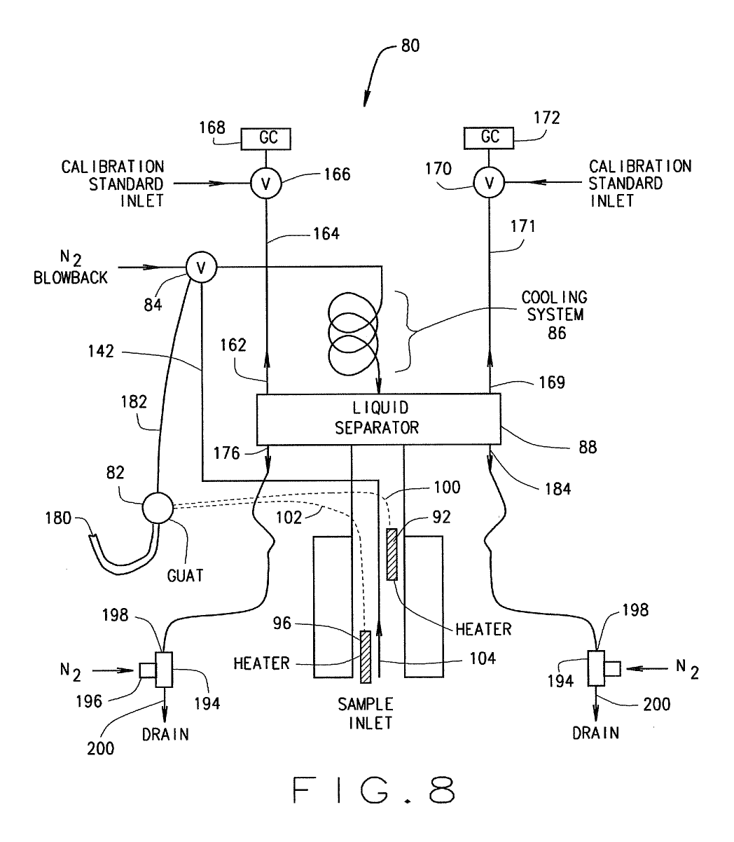

FIG. 8 is a schematic of the flow path of all gas and liquids passing through the liquid eliminator and other components of the system.

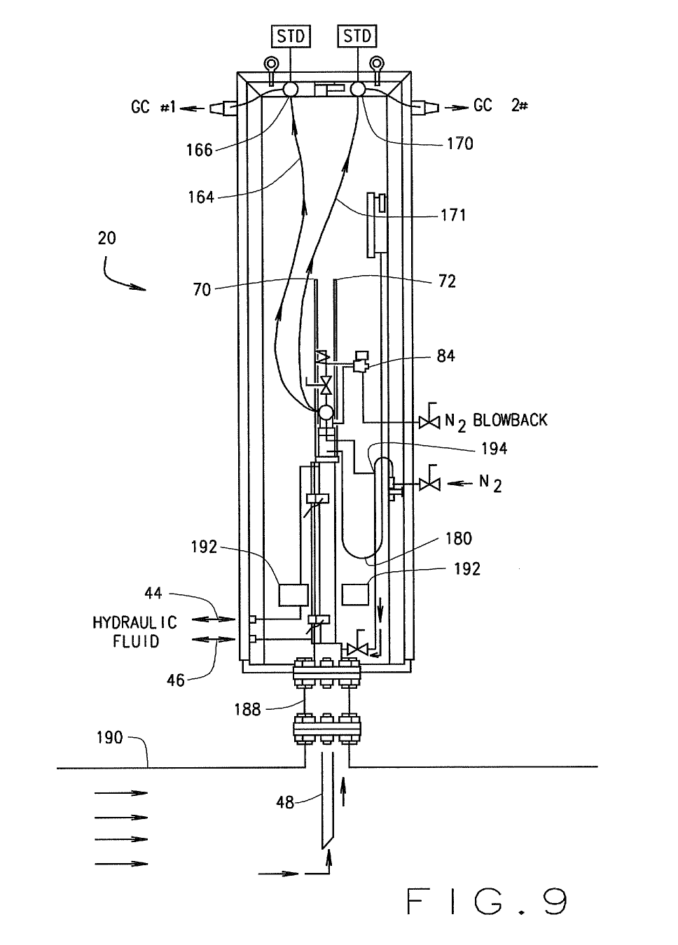

FIG. 9 is an elevation view of the cabinet with the doors removed. The cabinet is mounted on a block valve which is connected to the horizontal flare gas feed line.

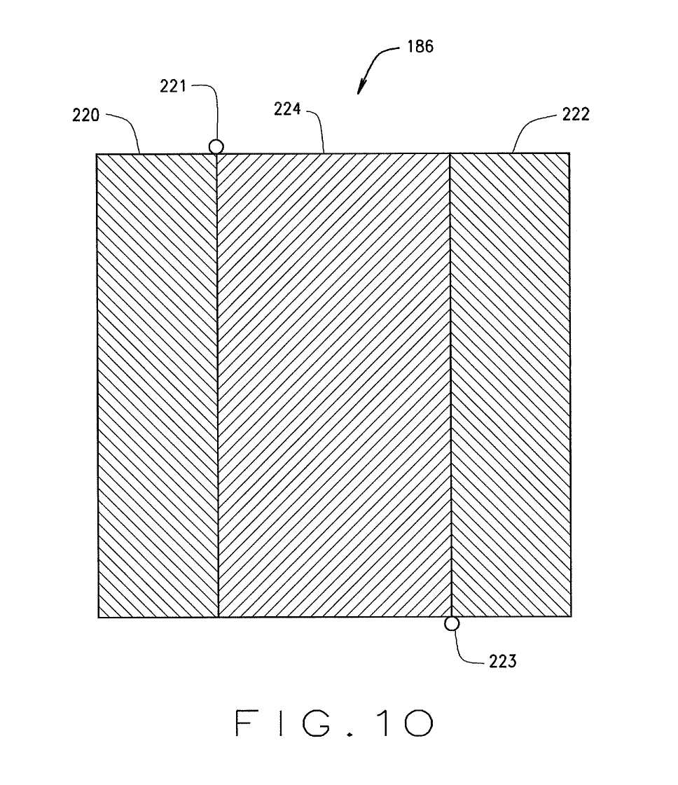

FIG. 10 is a top view of the cabinet with the doors closed.

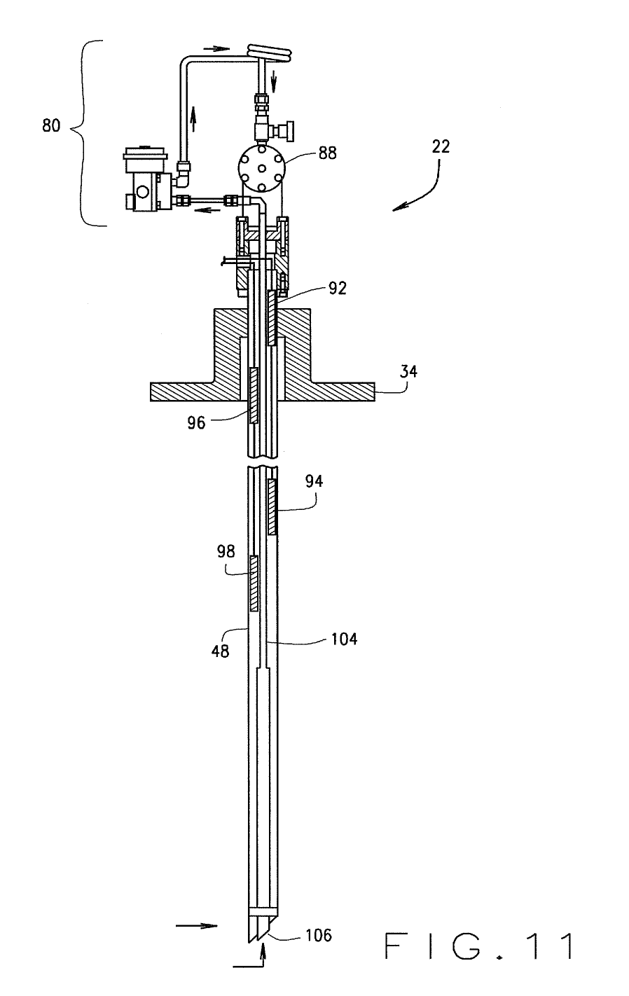

FIG. 11 is a section view of a static probe for the unburned flare gas system.

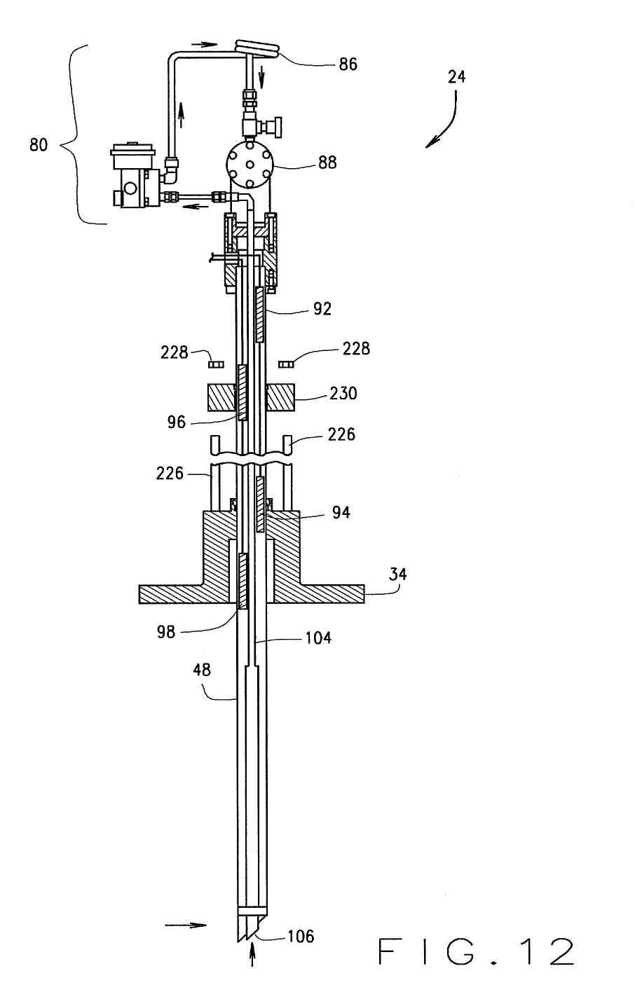

FIG. 12 is a section view of a manually inserted probe for the unburned flare gas system.

### DETAILED DESCRIPTION OF THE INVENTION

The automatic insertion flare gas sample system 20 is shown in FIGS. 1-10. The static flare gas sample system 22 in shown in FIG. 11 and the manual insertion flare gas sample system 24 are shown in FIG. 12. All three systems are used to sample unburned flare gas.

A means for automatically inserting a sample probe into a stream of unburned flare gas and withdrawing the sample probe form the stream of unburned sample gas is provided. Referring to FIGS. 1 and 2, the automatic insertion flare gas sample system 20 is shown in the withdrawn position with the probe 48 withdrawn from the unburned flare gas feed line, not shown in these figures. FIGS. 3 and 4 shown the automatic insertion flare gas sample system 20 with the probe 48 in the inserted position in the unburned flare gas feed line, not shown in these figures.

The automatic insertion assembly is generally identified by the bracket 28 in FIGS. 1 and 2. It may also be referred to as a means for automatically inserting and withdrawing the probe from the unburned flare gas feed line, not shown in these figures. The automatic insertion assembly is a double acting piston cylinder well known in the industry. An upper cap 30 is penetrated by a plurality of elongate stud bolts 32 which threadably engage a flange 34. The flange may be threaded to a block valve, not shown in these figures. The block valve may be threaded to a flange on the unburned flare gas feed line, not shown in these figures. A cylinder 40 is captured between the upper cap 30 and the flange 34. A piston 42 is slideably mounted in the cylinder and sealed against the cylinder 40 by circumferentially positioned O-rings. The piston defines an insertion chamber 50 and a withdrawal chamber 52 in the cylinder. A fluid, from a source of pressurized fluid, not shown, enters an insertion chamber 50 through the first port 44 to insert the probe 48 into the unburned flare gas feed line, not shown in these figures. A fluid, from the source of pressurized fluid, not shown, enters a withdrawal chamber 52 through the second port 46 to withdraw the probe 48 from the unburned flare gas feed line, not shown in these figures.

A means for determining the location of the sample probe is provided. A first reed switch 54 is slideably mounted on a rod 56 and a second reed switch 58 is slideably mounted on the rod 56. Conductors 60 are connected to the first reed switch and conductors 62 are connected to the second reed switch to send signals to and from the reed switches to a remote location. Magnets 64 are attached to the piston 42. As the magnets and the piston move past the reed switches, they trip the switch sending a signal through the conductors which is a means for determining whether the probe is withdrawn as shown in FIGS. 1 and 2 or inserted as shown in FIGS. 3 and 4 in the flare gas feed line, better seen in FIG. 9.

A processing assembly is generally identified by a bracket 80 in FIG. 1 and is described in greater detail in FIGS. 7 and 8. The processing assembly includes a GUAT junction box 82, which is an explosion proof junction box for electrical conductors; a three-way solenoid valve 84 to control an inert gas blowback system described in detail in connection with FIGS. 7 and 8; a cooling system 86 for the sample and a liquid separator identified by the bracket 88.

Referring now to FIG. 5, a means for heating the sample in the probe 48 is provided. A plurality of heaters may be staggered inside the probe. For illustrative purposes, a first heater 92, a second heater 94, a third heater 96 and a fourth heater 98 are located inside the probe 48 to reduce and/or eliminate the formation of liquids in the sample as it passes through the inlet 106 of the probe as indicated by the flow arrows. Conductors 100 connect to the first and second heaters to provide a source of electrical power to these heaters. Conductors 102 connect to the third and fourth heaters to provide a source of electrical power to these heaters. A sample conduit 104 runs the length of the probe 48. The sample conduit may be of unequal diameters, as shown or it may be of the same diameter, not shown. A large diameter 108 is located proximate the flare gas inlet 106 of the flare gas feed line, not shown in this figure and a smaller diameter 110 is located further up the probe 48. The purpose of the unequal diameters is to further retard the presence of liquids in the sample as it passes from the feed gas line up the probe. For example, assuming a flare gas feed line with a 48″ diameter, the larger diameter of the sample conduit may have an OD of 0.75 inches and an ID of 0.63 inches; the small diameter of the sample conduit may have an OD of 0.5 inches and an ID of 0.43 inches.

Referring to FIG. 6, the probe 48 is formed from an outer shell 112 which is thick and stiff to tolerate stress, due to the elevated velocity of the unburned flare gas as it passes by the probe in the flare gas feed line. Inside the probe is a first heater conduit 114 to receive the first heater, a second heater conduit 116 to receive the second heater, a third heater conduit 118 to receive the third heater and a fourth heater conduit 120 to receive the fourth heater. The number and location of the heaters is dependent on the length of the probe 48 and the size of the unburned flare gas feed line, not shown in this figure. For example, a flare gas feed line that is 48 inches in diameter may require a probe that penetrates about 22 inches into the flare gas feed line. The inlet for the probe should be in the middle third of the feed line to avoid liquids. Liquids, if any, tend to flow along the walls of a pipe. Therefore, keeping the probe inlet 106 away from the pipe wall is helpful. Each heater conduit has a closed end to isolate the heaters from the sample. An optional thermocouple conduit 122 is optionally located in the probe to receive a thermocouple 124 to measure heat in the probe and environs. A welded bottom 126, better seen in the preceding figure is placed in the tip of the probe to prevent ingress of the unburned flare gas except through the sample conduit located in the center of FIG. 6.

Referring now to FIGS. 7 and 8, the processing assembly and the liquid separator are shown in greater detail. The purpose of the processing assembly is to reduce and/or eliminate liquids from the sample before the sample reaches a GC. The liquid separator 88 has been enlarged in FIG. 7 and shown schematically in FIG. 8 with the rest of the processing assembly 80.

The sample flows up the sample conduit 104 of the probe 48 when the probe is in the inserted position of FIGS. 3 and 4 in the unburned flare gas feed line, best seen in FIG. 9. The sample passes through an outlet port 140 in the liquid separator and flows through a conduit 142, best seen in FIG. 5, into the solenoid activated three-way valve 84, through a conduit 144 into the cooling system 86, through the inlet port 146 of the liquid separator 88 to a Tee 148. At the Tee, the sample branches into two redundant flow paths. The flow path on the left side of the Tee will be described in detail. The flow path on the right side of the Tee is a mirror image of the other side.

The sample passes through an aperture 154 in a support 152 and through a filter 150 that will allow gas to pass but not liquid. The filter may be formed from a Teflon® membrane. Teflon is the brand name for tetrafluroethylene (TFE) produced by Du Pont. Other vendors also make other brands of TFE which may be suitable for use in this invention provided that they achieve separation of gas from liquids. Other products may also be suitable for use as a filter 150. For example, Tyvek® brand material from Du Pont de Nemours, E.I. Company may also be suitable as well as Millipore four micron filter paper from Pall Specialty Materials in Charlotte, N.C. After the sample passes through the filter 150, the sample should be dry, but to protect the expensive GCs from damage, a ball-type shut off valve 156 is provided in the exit of the liquid separator. If the filter fails or is working improperly, liquids or vapors will cause the ball 158 to rise and engage an O-ring 160 thus sealing the outlet port 162. In FIG. 7, the ball 158 is shown in the open position allowing gases to pass through the outlet port 162 from the liquid separator. These dry gases pass through a conduit 164 through a three way valve 166 to the first GC 168. The opposite side of the liquid separator 88 is identical.

A second outlet port 169 is formed in the opposite side of the liquid separator. Dry gases pass through the second outlet port, through a conduit 171 and into the second GC 172.

Optionally, a first sump 174 is formed on the left side of the liquid separator to collect liquids, if any. A drain 176 provides a means to remove accumulated liquids, if any from the first sump in the liquid separator. In one embodiment, a small vacuum is pulled on the drain 176. This small vacuum encourages liquids to move down the drain and away from the liquid separator. The right side of the liquid separator has a similar arrangement including drain 184.

If the membrane fails, the ball-type shut off valve will become vapor locked. In this situation, the system is shut down and the first vacuum breaker valve 178 and the second vacuum breaker valve 179 are opened.

Referring now to FIG. 8, electrical conductors 180 enter the GUAT junction box 82. Some of these conductors 182 pass from the junction box 82 to the 3-way solenoid operated nitrogen blowback valve 84. Some of the conductors 100 and 102 connect with the heaters 92 and 96 to provide heat to the probe. As best seen in the next figure, the electrical conductors 180 droop down in a J-shape to better move up and down with the processing assembly 80 as the probe is inserted and withdrawn from the flare gas feed line.

A sample from the unburned flare gas feed line, not shown in this figure, enters the sample conduit 104 and passes to the 3-way valve 84, through the cooling system 86, and into the liquid separator 88, the sample passes through the pair of filters to remove any liquids and exits the separator at outlet ports 162 and 169. The dry gas from outlet port 162 passes through the 3-way valve 166 and into the first GC 168. The dry gas from the outlet port 169 passes through the 3-way valve 170 and into the second GC 172.

Optionally, the liquid separator 88 may be equipped with drains 176 and 184. An eductor 194 is T-shaped and connects to a motive line 196 for inlet gas, a suction line 198 to pull the vacuum and a discharge line 200 for the nitrogen and any liquids that may be drained/pulled/educted from the liquid separator and the drains 176 and 184.

The 3-way valves 166 and 170 are used to feed calibration standards into the GCs as is well known in the art. When the calibration standard is being fed the GCs, the sample feed is shut off. And conversely, when the sample feed is on, the calibration standard is off.

Optionally, the liquid separator 88 may be equipped with a nitrogen blowback system. If the liquid separator, cooling system and/or probe are fouled with liquids or otherwise needs to be cleaned out, nitrogen from a source of pressurized nitrogen, not shown, is blown through the 3-way valve 84 and the sample conduit 104 back into the feed gas line.

In one embodiment of the present invention, flare gas temperatures range from approximately 200° F. to approximately 250° F. in the feed lines. In this embodiment, the sample system includes a heating system to warm the sample conduit to prevent condensation as the sample leaves the flare gas feed line and passes through the sample conduit 104. The setting for the heating system will vary according to each installation. Various factors include the ambient temperatures, the length of the probe 48, the temperature range of the feed gas line and other factors. In this embodiment, the heating system operates at a range of from approximately 212° F. to approximately 230° F. During an upset, temperatures of unburned flue gas may spike upward and need to be cooled. The purpose of the cooling system 86 is to keep the temperature of the sample below the operational maximum, which for this embodiment is approximately 400° F. The filter fails at sustained temperatures in excess of 400° F. In this embodiment, the cooling system is pre-set to reduce the temperature of the sample to about 385° F. before it enters the liquid separator 88.

FIG. 9 is an open view of the cabinet 186 showing the auto insertion flare gas sample system 20. All electrical connections in, on and in proximity to the cabinet must be “explosion proof” or “intrinsically safe”. In other words, the sample system, cabinet and associated electrical connections should be compliant with Class 1, Div. 1, Group C & D of the National Electrical Code. The probe 48 is shown in the inserted position. The probe 48 passes through a block valve 188 and into the flare gas feed line 190.

A plurality of heaters 192 are placed in the insulated cabinet to help keep the system warm and reduce the precipitation of liquids into the sample. In one embodiment, these heaters are designed to operate at a set point of about 230° F. This temperature is above the boiling point which retards formation of liquids as the flare gas passes through the sample system. The heaters may be in use 12 months a year. The temperature range of the heaters depends on the elevation of the installation site, the size of the cabinet and typical weather conditions, among other factors. (Elevation is relevant because the boiling point increases at higher elevations.) A first port 44 and a second port 46 allow fluid to enter the double acting piston/cylinder which moves the probe 48 in and out of the flare gas feed line. During insertion of the probe, the port 44 acts as an inlet and the port 46 acts as an outlet. During withdrawal of the probe, the port 46 as an inlet and the port 44 act as an outlet for the fluid.

The optional drains work with an eductor 194. One educator that may be suitable for use in this invention is a Mini-Eductor Part Nos. 611210-093, -060, -030 and -015 from Fox Valve Development Corporation of Dover, N.J., www.foxvalve.com. The educator 194 is a simple venture, with an inlet and outlet for nitrogen or some other inert gas. The educator is T-shaped and connects to a motive line 196 for the inlet gas such as nitrogen, a suction line 198 to pull the vacuum from the drains 176 and 184 and a discharge line 200 for the nitrogen and any liquids that may be drained/pulled/educted from the drains in the liquid separator as best seen in the preceding figure. Typically, the nitrogen passing through the eductor and any liquids from the optional drains are directed back into the feed gas line. The eductor has a needle valve, not shown, upstream to enable precise adjustments of the vacuum. Typically the amount of vacuum is adjusted in the field, after installation of the apparatus. If too much vacuum is pulled on drain, no sample will reach the GCs. This eductor may pull from zero to about 30 inches of mercury in the drains 176 and 184.

FIG. 10 is a top view of the insulated and heated cabinet 186 for the unburned flare gas sample system. A front insulated door 220 is removably connected to the cabinet 186 by hinges 221, pins or other connecting means. A rear insulated door 222 is connected to the cabinet 186 by hinges 223, pins or other connecting means. In one embodiment, each insulated door is about 9 inches thick. The cabinet is about 18 inches thick. In one embodiment, the insulation in the doors and in the cabinet provides about 0.19 Btu-inch/hour-foot squared-degrees Fahrenheit of insulation.

FIG. 11 is a section view of a static sample system 22 for unburned flare gas. The primary difference between the sample system 22 and the preceding sample system in FIGS. 1-11 is the absence of the automatic insertion assembly 28. All other components are substantially the same. The probe 48 is welded to the flange 34 to secure the probe in an inserted position in the flare gas feed line.

FIG. 12 is a section view of a manual insertion sample system 24 for unburned flare gas. The primary difference between the sample system 24 and the sample system in FIGS. 1-11 is the absence of the automatic insertion assembly 28. The sample system 24 is manually inserted into the flare gas feed line and depending on the pressure in the flare gas feed line is manually withdrawn. A plurality of stud bolts 226 extend from the flange 34 parallel to the probe 48. A flange 230 is adjustably clamped to the probe 48. The flange 230 has a plurality of apertures, not shown, for the plurality of stud bolts 226 to pass through. A plurality of nuts 228 are then threaded on the stud bolts to hold the flange 230 and the probe in place. The nuts may be unscrewed to withdraw the probe from the flare gas feed line.

1. A sample system for unburned flare gas comprising:
means for automatically inserting a sample probe into a stream of unburned flare gas and withdrawing the sample probe from the stream of unburned flare gas;
the sample probe having;
an open ended sample gas tube to transport unburned flare gas from the stream to the sample system;
at least one closed end heater tube coaxial with the sample gas tube sized and arranged to receive a heating element; and
the sample gas tube being formed of unequal diameters with the largest diameter in proximity to the stream of unburned flare gas;
a liquid separator to separate liquids from the unburned flare gas, having;
a filter that passes gas, but not liquids;
a controllable vacuum drain to pull liquids from the liquid separator; and
an automatic shut off valve to prevent liquids from leaving the liquid separator;
a cooling system to cool the sample below a maximum operational temperature of the sample system, before the sample enters the liquid separator;
means for determining the location of the sample probe;
a blowback system using an inert gas for purging liquids from the cooling system and the liquid separator; and
a heated cabinet to contain the automatic insertion sample system.

2. A sample system for unburned flare gas comprising:
means for automatically inserting a sample probe into a stream of unburned flare gas and withdrawing the sample probe from the stream of unburned flare gas;
the sample probe having;
an open ended sample gas tube to transport unburned flare gas from the stream to the sample system; and
at least one closed end heater tube coaxial with the sample gas tube sized and arranged to receive a heating element;
a liquid separator to separate liquids from the unburned flare gas, having;
a filter that passes gas, but not liquids; and
an automatic shut off valve to prevent liquids from leaving the liquid separator; and
a cooling system to cool the sample below a maximum operational temperature of the sample system, before the sample enters the liquid separator;

3. The system of claim 2 further including a heated cabinet to contain the automatic insertion sample system for unburned flare gas.

4. The system of claim 3 further including a drain to remove liquids from the liquid separator.

5. The system of claim 4 further including a blowback system using an inert gas for purging liquids from the automatic insertion sample system.

6. The system of claim 5 further including: at least one closed sensor tube parallel to the sample gas tube, sized and arranged to receive a temperature transducer.

7. The system of claim 6 further including means for determining the location of the sample probe.

8. The system of claim 7 wherein the open ended sample gas tube is of unequal diameters, with the largest diameter portion in proximity to the stream of unburned flare gas.

9. A sample system for unburned flare gas comprising:
the sample probe having;
an open ended sample gas tube to transport unburned flare gas from the stream to the sample system; and
at least one closed end heater tube coaxial with the sample gas tube sized and arranged to receive a heating element;
a liquid separator to separate liquids from the unburned flare gas, having;
a filter that passes gas, but not liquids; and
an automatic shut off valve to prevent liquids from leaving the liquid separator; and
a cooling system to cool the sample below a maximum operational temperature of the sample system, before the sample enters the liquid separator;

10. The system of claim 9 further including: means for automatically inserting a sample probe into a stream of unburned flare gas and withdrawing the sample probe from the stream of unburned flare gas.

11. The system of claim 9 further including means for manually inserting a sample probe into a stream of unburned flare gas and withdrawing the sample probe from the stream unburned sample gas.

12. The system of claim 9 wherein the sample probe is permanently inserted into an unburned feed gas line.

13. The system of claim 12 further including a heated cabinet to contain the automatic insertion sample system for unburned flare gas.

14. The system of claim 13 further including: at least one closed sensor tube parallel to the sample gas tube, sized and arranged to receive a temperature transducer.

15. The system of claim 14 further including a drain to remove liquids from the liquid separator.

16. The system of claim 15 wherein the open ended sample gas tube is of unequal diameters, with the largest diameter portion in proximity to the stream of unburned flare gas.

17. The system of claim 16 further including a blowback system using an inert gas for purging liquids from the automatic insertion sample system.

18. The system of claim 17 further including means for determining the location of the sample probe.
